(19) United States
(12) Patent Application Publication
(10) Pub. No.: US 2024/0391463 A1
(43) Pub. Date: Nov. 28, 2024

(54) PERFORMING AN AUTOMATED LANE CHANGE MANEUVER FOR A MOTOR VEHICLE

(71) Applicants: CARIAD SE, Wolfsburg (DE); VOLKSWAGEN AKTIENGESELLSCHAFT, Wolfsburg (DE)

(72) Inventors: Jannis HOPPE, Wolfsburg (DE); Dominic HALBROTH, Gaimersheim (DE); Michael STARK, Wolfsburg (DE)

(21) Appl. No.: 18/674,585

(22) Filed: May 24, 2024

(30) Foreign Application Priority Data
May 26, 2023 (DE) 102023113984.3

(51) Int. Cl. B60W 30/18; B60W 30/16; B60W 50/10

(52) U.S. Cl. CPC B60W 30/18163; B60W 30/16; B60W 50/10; B60W 2420/403; B60W 2420/408; B60W 2520/10; B60W 2554/80

(57) ABSTRACT

The disclosure relates to a motor vehicle performing a lane change maneuver in an at least partially automated manner. A first safety distance of the motor vehicle in relation to a target object relevant to the lane change maneuver is ascertained based on transverse guidance data of a transverse guidance module of the motor vehicle. An activation state of a longitudinal guidance module of the motor vehicle is ascertained, which indicates that the longitudinal guidance module is activated. A control parameter is ascertained, which indicates that the longitudinal guidance module considers the target object for the longitudinal guidance maneuver. Only if the activation state and the control parameter are present, a second safety distance, which is different from the first safety distance, is ascertained. The lane change maneuver is performed by way of the transverse guidance module in compliance with the second safety distance to the target object.

### BACKGROUND

### Technical Field

The disclosure relates to a method for performing a lane change maneuver in an at least partially automated manner for a or by way of a motor vehicle. Furthermore, the disclosure also relates to a motor vehicle with a corresponding transverse guidance module for performing a corresponding lane change maneuver.

### Description of the Related Art

There are motor vehicles, in which a lane change can be performed by way of a transversely guiding driver assistance system in automated or assisted manner, thus without support of a driver. For example, the driver assistance system is referred to as lane change assistant. For performing the lane change, the lane change assistant for example includes a transverse guidance module, which can correspondingly initiate and perform the associated driving intervention such as for example steering and/or accelerating. By controlling corresponding vehicle actuators, the motor vehicle can autonomously change the lane, preferably in automated or assisted manner.

This type of the lane change is an automatic steering function (ACSF: Automatically Commanded Steering Function) of the category C, which is for example regulated by law in Europe and additionally is subject to considerations related to product liability. Therein, safety distances to front vehicles and to the rearward traffic, thus foreign vehicles in the environment of the motor vehicle (ego vehicle), for example have to be complied with due to the legal requirements. If a corresponding safety distance should not be able to be complied with in an assisted lane change, the lane change procedure is suppressed or aborted. Corresponding lane change assistants are known per se from the prior art.

For example, DE 10 2017 208 473 A1 discloses a control unit for the at least partially automated transverse guidance of a vehicle. Therein, an abortion trajectory is to be ascertained in response to the presence of an abortion condition for the lane change, to orient the vehicle consistent with a lane.

US 2022/0073076 A1 discloses a method for simulating a lane change trajectory for a vehicle. Therein, the surrounding road traffic is taken into account.

CN 114475596 A discloses a method for securing a lane change maneuver. Therein, an order or vehicles in a queue is taken into account for the lane change.

It is disadvantageous in the lane change assistants from the prior art that the automated lane change maneuver is aborted upon non-compliance with the safety distance and therein the driver for example has to take over the steering. This results in a lower customer use as well as a reduced confidence in the function. In addition, the lane change assistant is not available in certain situations.

### BRIEF SUMMARY

Embodiments of the disclosure increase the availability of the automated or assisted lane change maneuver in a motor vehicle.

The disclosure is based on the realization that in performing a (partially) automated lane change maneuver, the safety distances for example to other traffic participants are calculated independently of the status of a potentially active longitudinally guiding driver assistance system, thus for example a longitudinal guidance module of the motor vehicle, up to now. Today, such a longitudinal guidance module is for example employed in driver assistance systems to for example take over the longitudinal guidance of the motor vehicle in assisted or automated manner. Therein, it is for example about maintaining the distance to foreign vehicles or a desired driving speed. In order to avoid abrupt acceleration or braking maneuvers in the longitudinal guidance, there are longitudinally guiding systems, which implement a delay in the response. Thereby, it can for example occur that a preset target distance to a preceding foreign vehicle is undershot (dipping) or exceeded at least for a short time. In transversely guiding systems, this variable or dynamic safety distance does not exist up to now. Therefore, in the lane change, the target distance, which is for example required by law, is always complied with in conventional lane change assistants.

Thereto, safety distances in the lane change can be determined depending on the status of a potentially active longitudinally guiding system. Hereto, a longitudinal control object, thus a target object for the longitudinal control, is in particular also considered in the transverse control or transverse guidance for the safety distance in the assisted lane change. Therein, it is exploited that upon use of a driver assistance system, it can be much faster responded to changed environmental circumstances upon need than it is for example possible by a human driver. Thus, a corresponding safety distance to a preceding or following foreign vehicle can for example be reduced without substantial safety losses in the vehicle guidance or in the road traffic occurring.

Hereto, according to one aspect, the disclosure proposes a method for performing a lane change maneuver in at least partially automated manner for a or by way of a motor vehicle. Presently, the lane change maneuver can for example include a lane change or a traffic lane change. Additionally or alternatively, the lane change maneuver can include further driving maneuvers, which are associated with the lane change. For example, an acceleration on the initial lane or ego lane can belong to it.

In the method, a first safety distance of the motor vehicle, which is also referred to as ego vehicle in the following, in relation to a target object relevant to the lane change maneuver, thus for example an foreign vehicle, is first ascertained or determined based on transverse guidance data of a transverse guidance module of the motor vehicle. The calculation of the respective safety distance is preferably effected based on the transverse guidance data according to standard methods as they are known per se from the prior art for a lane change.

Subsequently, an activation state of a longitudinal guidance module of the motor vehicle is ascertained or determined in the method. The activation state indicates that the longitudinal guidance module is activated or used for performing a longitudinal guidance maneuver of the motor vehicle in at least partially automated manner. This means, it is known by the activation state if the longitudinal guidance module is implemented and/or switched on in the motor vehicle. Presently, the longitudinal guidance module is in particular regarded as activated if driving maneuvers relating to the longitudinal guidance are performed by way of the longitudinal guidance module, thus a distance or a vehicle speed is for example adjusted or preset in at least partially automated manner.

Furthermore, at least one control parameter is ascertained or determined in the method, which indicates that the longitudinal guidance module considers the target object for the longitudinal guidance maneuver. This means, it is examined if the longitudinal guidance adjusts to the target object. The respective control parameter is thus an attribute or a state, which indicates if the target object is present and is used as the target object for the longitudinal guidance.

Only if the activation state and the control parameter are present, thus the longitudinal guidance module is active, and the target object is captured by the longitudinal guidance module, a second safety distance of the motor vehicle in relation to the target object is ascertained or determined in the method. Therein, the second safety distance is different from the first safety distance by a predetermined limit amount. This means, the second safety distance is for example reduced or increased by the limit amount. Performing the lane change maneuver is then effected by way of the transverse guidance module in compliance with the second safety distance to the target object in the method.

In contrast, if the activation state and/or the control parameter are not present, the first safety distance is preferably considered for the lane change maneuver. This is for example the case if the longitudinal guidance module is deactivated. Performing the lane change maneuver is thus effected by way of the transverse guidance module in compliance with the first safety distance to the target object.

Thus, the status of the longitudinally guiding system and in particular the currently active control object (target object), which is active for the longitudinal control, is incorporated in the assessment of the environment and the safety distance. In other words, the calculation of a target distance or safety distance to the target object in the lane change is effected depending on whether the longitudinal guidance is activated or deactivated. If the longitudinal guidance is active and adjusts to the target object, a different safety distance (second safety distance) can be considered than if the longitudinal guidance is deactivated. If the longitudinal guidance is deactivated, the regular safety distance (first safety distance) is in particular complied with or adjusted.

Hereby, the advantage arises that the safety distance can be dynamically adapted to the respective traffic situation. Thereby, the driving behavior of a human driver can be simulated or modeled by way of the transverse guidance module in particular in the lane change. For an occupant in the motor vehicle, thus, an increased user comfort arises in the assisted or automated driving. In addition, it can thereby be avoided that an assisted lane change is regularly aborted if the regular safety distance for example cannot be complied with. Thus, the availability of the assisted lane change can be increased and the confidence in the lane change function in the motor vehicle can thereby be enhanced.

Preferably, the respective safety distance is restricted or determined by legal requirements or a preset internal or external rule. For example, there is the so-called UN/ECE regulation No. 79 in Europe, which contains provisions or standards for automatic steering functions. Furthermore, considerations related to product liability can for example be taken into account by the manufacturer as a rule for the respective safety distance.

The longitudinal guidance module and the transverse guidance module can for example be encompassed by a respective electronic vehicle guidance system or driver assistance system of the motor vehicle. An electronic system can be understood by an electronic vehicle guidance system, which is configured to guide a vehicle in fully automatic or fully autonomous manner on the one hand or in partially automatic or assisted manner on the other hand, in particular without an intervention in a control by a human driver being required. The vehicle at least partially automatically performs all of the required functions, in particular driving maneuvers, such as for example steering, braking and/or accelerating maneuvers, the observation and capture of the road traffic as well as corresponding responses. The degree of automation is for example preset by the standard SAE J3016 in respective stages or in levels. For example, the respective driving maneuver (longitudinal guidance maneuver or lane change maneuver) is effected in assisted manner if the electronic vehicle guidance system is classified in level 1 or level 2. In contrast thereto, the respective driving maneuver is performed in automated manner if the electronic vehicle guidance system is classified in level 3 or higher. In the following, the term “automated” is used for simplification, wherein the assisted guidance also comes within.

Presently, in particular transversely guiding driving maneuvers are understood by a transverse guidance. They in particular relate to vehicle movements perpendicular or transverse to a direction of travel of the motor vehicle (steering). Additionally or alternatively to the lane change maneuver, the transverse guidance module can perform other transversely guiding driving maneuvers. For example, the transverse guidance module can assist in evasive maneuvers and/or turning maneuvers and/or parking maneuvers. Presently, in particular longitudinally guiding driving maneuvers are understood by a longitudinal guidance. They in particular relate to vehicle movements parallel to or in the direction of the direction of travel (deceleration, acceleration). For example, maneuvers for decelerating, accelerating or maintaining the vehicle speed belong thereto.

Calculating and/or ascertaining the respective driving maneuver are preferably effected according to standard methods, which are known per se from the prior art. Hereto, the transverse guidance data and longitudinal guidance data, respectively, from the respective module are for example used. Therein, the transverse guidance data and longitudinal guidance data for example include attributes and criteria, which specify when and if the transverse guidance or the longitudinal guidance is allowed or can be performed. For example, the transverse guidance data and longitudinal guidance data include results of an environmental analysis or environmental observation of the ego vehicle. Preferably, the transverse guidance data and longitudinal guidance data include a position of a foreign object or target object like a foreign vehicle in relation to the ego vehicle, an object type (vehicle type, lane) and/or object state (speed, dimensions). Furthermore, the transverse guidance data and longitudinal guidance data can include vehicle data to the ego vehicle, such as for example a driving speed or the dimensions, Preferably, anti-flicker measures for objects in the boundary area are taken into account in the calculation.

In the longitudinal guidance module, a control logic or decision logic is for example implemented for implementing a longitudinal guidance. Upon actuation of a turn signal (direction indicator) of the ego vehicle in the longitudinally guided operation, it can ascertain based on an algorithm if the distance is to be adjusted to a preceding vehicle in the ego lane or to a vehicle, which moves on the target lane (selecting the target object). After evaluation of the logic, it is adjusted to the corresponding vehicle for a fixed time as long as a situation assessed as critical with respect to the vehicle on the ego lane (lane, on which the ego vehicle drives) is not present. In the transverse guidance module, an analogous control logic or decision logic is for example implemented for implementing a transverse guidance to carry out the automated lane change.

In order to be able to convert the ascertained driving maneuver into a vehicle movement, associated vehicle actuators can for example be controlled by way of the transverse guidance module and the longitudinal guidance module, respectively. For example, a drive or powertrain, a steering system and/or a braking system belong thereto. By the control, the ego vehicle performs the lane change (or the respectively desired driving maneuver) in automated manner. This means, a vehicle movement from the initial lane to the target lane is carried out.

Embodiments, by which additional advantages arise, belong to the disclosure.

According to an embodiment, a lane change status of the transverse guidance module is ascertained. The lane change status indicates that performing the lane change maneuver in compliance with the first safety distance to the target object has been initiated or started by way of the transverse guidance module within a preferably immediately preceding, predetermined time interval. The second safety distance is additionally only ascertained if the lane change status is present. Thus, only if the lane change status is present, the lane change is correspondingly performed in compliance with the second safety distance. Otherwise, for example if the time interval is exceeded, the lane change is aborted.

Hereby, the advantage arises that an already initiated lane change can also be still further performed upon undershooting the regular safety distance. Thus, a lane change maneuver does not have to be aborted in the middle of the lane change. For example, the predetermined time interval can be 1 to 5 seconds. This time interval serves for debouncing. Thereby, a decision time is allowed to the longitudinal guidance module to for example select a target object on the target lane as a control object (control parameter is present) even if the lane change is already carried out.

According to an embodiment, a probability of entry of the target object into the second safety distance is ascertained. The lane change maneuver is performed in compliance with the second safety distance only if the probability of entry falls below a preset limit value. Put another way, the lane change maneuver is aborted or terminated if it is ascertained based on the probability of entry that the target object presumably enters into the second safety distance or is located there during the lane change maneuver. Preferably, the limit value is at most at 10%, particular, at most at 5%. Thus, it can be ensured that the lane is only changed if the entry of the target object into the second safety distance can be predicted or ascertained with a probability of 10% or less. Hereby, it can be ensured that deceleration of the motor vehicle is for example still possible in time if needed before a collision with the target object occurs.

According to an embodiment, an override state of the longitudinal guidance module is ascertained, which indicates that a passenger of the motor vehicle at least partially overrides or invalidates performing the longitudinal guidance maneuver by way of the longitudinal guidance module by a driving intervention. Performing the lane change maneuver in compliance with the second safety distance is prevented if the override state is present. Thus, the lane change maneuver is aborted or not enabled in this case. In contrast, if the override state is not present, the lane change maneuver is performed as previously described.

For example, a driver intervention is present if a passenger, thus for example an occupant or driver of the motor vehicle, intervenes in the (longitudinally guided) control of the motor vehicle. This for example happens in the so-called invalidation, thus if the driver himself accelerates. Then the automated longitudinal guidance maneuver is interrupted or paused.

According to an embodiment, the second safety distance is reduced by a predetermined limit amount compared to the first safety distance. This means, the second safety distance is selected smaller than the first safety distance. Thus, it can for example be driven up closer to a preceding foreign vehicle on the foreign lane or target lane in the lane change without the lane change maneuver being aborted. Preferably, the second safety distance is reduced by at least 10% or 20% or 50% compared to the first safety distance.

In this context, according to an embodiment, in ascertaining the second safety distance, a preset emergency braking distance to the target object is considered for performing the longitudinal guidance maneuver. Therein, the emergency braking distance indicates a distance to the target object, which is at least required in order that an emergency braking module of the motor vehicle can still prevent a collision with the target object by way of emergency braking maneuver. Therein, the emergency braking maneuver is preferably performed in completely automated or autonomous manner. Alternatively or additionally, an assisted performance with an assistance by the passenger is for example possible.

Thus, three distance ranges in particular arise for the lane change maneuver. Therein, the emergency braking distance to the target object is smaller than the second safety distance, and the second safety distance is smaller than the first safety distance. Therein, the second safety distance is preset by a distance range with a minimum value and a maximum value, wherein the minimum value is the emergency braking distance and the maximum value is the first safety distance.

Additionally or alternatively, the second safety distance can for example be ascertained or calculated based on comfort data for a braking maneuver by way of the motor vehicle. For example, a preset maximum braking intensity can be considered in the comfort data, by which a wellbeing of the passenger is impaired as little as possible in deceleration. The maximum braking intensity can for example be ascertained by test experiments or a computing model. Preferably, the second safety distance can then be selected such that a collision with the target object can just be prevented in performing a braking maneuver with the maximum braking intensity.

According to an embodiment, the target object is a foreign vehicle on a target lane, onto which the motor vehicle is to be steered by performing the lane change maneuver. Therein, the foreign vehicle can for example be a preceding or following vehicle.

According to an embodiment, the respective safety distance, thus the first and/or the second safety distance, is determined depending on a vehicle speed of the motor vehicle and/or of the target object. For example, the vehicle speed can be encompassed by the transverse guidance data. The ascertainment of the vehicle speed can for example be effected according to standard methods. For example, a speed sensor of the ego vehicle can be read out. Ascertaining the vehicle speed of the foreign vehicle can for example be ascertained by way of radar measurement or based on image analysis from an image or video of the foreign vehicle in the environment. Thereto, the motor vehicle can for example comprise corresponding sensor technology.

For application cases or application situations, which can arise in the method and which are not explicitly described here, it can be provided that an error message and/or a request for inputting a user feedback are output and/or a default setting and/or a predetermined initial state are adjusted according to the method.

According to an aspect, the disclosure relates to a motor vehicle with a transverse guidance module at least for performing a lane change maneuver. Additionally or alternatively, the transverse guidance module can for example also be used for other transversely guiding maneuvers such as for example an evasive maneuver or a turning maneuver or a parking maneuver. Furthermore, the motor vehicle includes a longitudinal guidance module for performing a longitudinal guidance maneuver. The motor vehicle also includes control logic for performing a method as it was previously described. This means, the control logic can be formed to perform or initiate a lane change maneuver in at least partially automated manner. Thereto, corresponding vehicle maneuvers can for example be calculated and corresponding vehicle actuators can be controlled by way of the control logic.

The control logic is preferably encompassed by the transverse guidance module. However, additionally or alternatively, the control logic can for example be encompassed by the longitudinal guidance module or another vehicle component such as for example an electronic control unit of the motor vehicle or an on-board computer. The control logic can for example be present as a data processing device or processor device. Hereto, the processor device can comprise at least one microprocessor and/or at least one microcontroller and/or at least one FPGA (Field Programmable Gate Array) and/or at least one DSP (Digital Signal Processor). Furthermore, the processor device can comprise a program code, which is configured to perform the embodiment of the method according to the disclosure upon execution by the processor device. For example, the program code can be stored in a data memory of the processor device. For example, the processor device can be based on a circuit board and/or on at least one SoC (System on Chip). Preferably, the motor vehicle is a car, in particular a passenger car or truck or a passenger bus or motorcycle.

According to an embodiment, the motor vehicle includes a camera system for the environmental capture and a radar system for the environmental capture. The camera system includes the transverse guidance module and the radar system includes the longitudinal guidance module. The camera system and the radar system can be understood as environmental sensor systems of the motor vehicle. Therein, the respective environmental sensor system is capable of generating sensor data or sensor signals, which image, represent or reproduce an environment of the respective system, in particular of the motor vehicle. The sensor data or sensor signals can be evaluated in a manner known per se, for example by way of object recognition or image analysis, to for example recognize the target object or other objects in the environment, such as for example lanes, or other foreign vehicles and/or the state thereof. The result of this evaluation can be passed or provided to the respective longitudinal guidance or transverse guidance module in the form of longitudinal guidance data or transverse guidance data.

For example, the longitudinal guidance module and/or transverse guidance module can be implemented in the form of software or hardware. In particular, the respective module can for example consist of hardware and a software portion implemented on the hardware. Presently, a software module can be understood as a part of a software code, which is functionally connected and combined to one unit. A software module can include or implement multiple processing steps and/or data structures. A method step for providing a software module can be understood such that it includes providing the corresponding software code in computer-readable form on a computer-readable storage medium.

Developments of the method according to the disclosure, which comprise features, as they have already been described in context of the developments of the method according to the disclosure, also belong to the disclosure. For this reason, the corresponding developments of the method according to the disclosure are not again described here. The disclosure also includes the combinations of the features of the described embodiments.

### BRIEF DESCRIPTION OF THE SEVERAL VIEWS OF THE DRAWINGS

In the following, execution examples of the disclosure are described.

FIG. 1 is a schematic representation of a driving situation, in which a motor vehicle performs a lane change maneuver in an automated manner; and

FIG. 2 is a schematic method flow diagram for a method for performing the lane change maneuver for the motor vehicle in an at least partially automated manner.

### DETAILED DESCRIPTION

The execution examples explained in the following are advantageous embodiments of the disclosure. In the execution examples, the described components each represent individual features of the disclosure to be considered independently of each other, which also each develop the disclosure independently of each other and thereby are also to be regarded as a constituent of the disclosure in individual manner or in a combination different from the shown one. Furthermore, the described execution examples can also be supplemented by further ones of the already described features of the disclosure.

In the figures, functionally identical elements are each provided with the same reference characters.

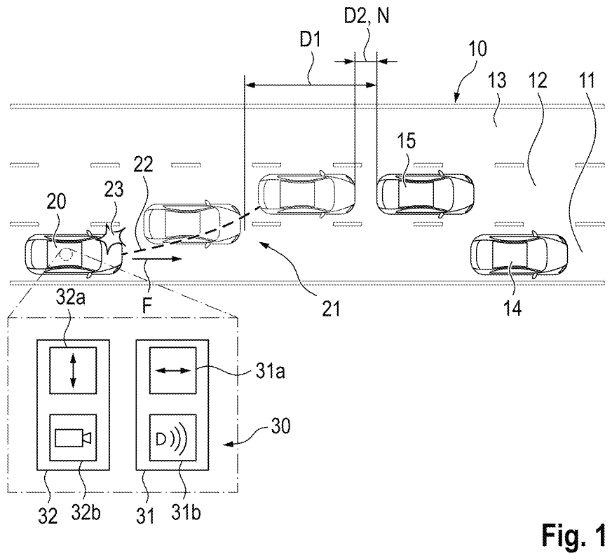

FIG. 1 shows a driving situation or a traffic situation in schematic representation, in which a motor vehicle 20 is to perform or performs a lane change maneuver 21 in automated manner. Thereto, a roadway with three lanes is illustrated in FIG. 1. According to the embodiment in FIG. 1, the roadway is for example a highway 10. The three lanes are an ego lane 11 or initial lane, a target lane 12 and a further lane 13. In the described traffic situation, the motor vehicle 20 is on the ego lane 11 and is to change or be guided onto the target lane 12 by way of the lane change maneuver 21. Presently, the lane change maneuver 21 exemplarily includes the lane change from the ego lane 11 to the target lane 12. Thereto, the ego vehicle 20 follows a preset trajectory 22. Besides the lane change, the lane change maneuver 21 can for example also include acceleration or deceleration on the ego lane 11 and/or further driving maneuvers, which are required or provided for the lane change.

Both on the ego lane 11 and on the target lane 12, there are other motor vehicles, which are presently referred to as foreign vehicles 14, 15. The foreign vehicles are in front of the motor vehicle 20 in a direction of travel F. In the present embodiment, all of the three vehicles are exemplarily represented as passenger cars.

The lane change maneuver 21 is to be performed in an at least partially automated manner, thus, in an assisted or automated or autonomous manner. Thereto, the ego vehicle 20 includes a driving assistant, which is presently referred to as travel assist 30. The travel assist 30 is an electronic vehicle guidance system, by way of which the ego vehicle 20 can be fully automatically or partially automatically guided, in particular without an intervention in a control by a driver being required. The ego vehicle 20 automatically performs all of the required functions such as for example steering, braking and/or accelerating maneuvers, the observation and capture of the road traffic as well as corresponding responses. Thereto, the travel assist 30 presently includes two systems, by which different driving maneuvers can be performed.

One system is a radar system 31, which is presently exemplarily responsible for longitudinal guidance maneuvers. A further system is a camera system 32, which is presently exemplarily responsible for transverse guidance maneuvers and in particular the lane change maneuver 21. By “responsible”, it is herein meant that the respective system ascertains and performs all of the required calculations, controls and interventions, which are required for the respectively desired driving maneuver. Presently, the radar takes over the longitudinal guidance, thus the control of the ego vehicle 20 in direction of travel F. For example, stopping or adjusting a certain or desired driving speed and/or adjusting a distance to another vehicle on the respective initial lane belongs to the longitudinal guidance. Presently, the camera system 32 takes over the transverse guidance of the ego vehicle 20, that is the control of the ego vehicle 20 transverse or perpendicular to the direction of travel F. For example, the lane change maneuver 21 or other vehicle maneuvers, which intervene in the steering, belong thereto.

For observing or capturing the environment of the ego vehicle 20, the radar system 31 and the camera system 32 include one or more environmental sensors. Sensor data or sensor signals can be generated by the respective environmental sensors, which image, represent or reproduce the environment of the ego vehicle 20. As the environmental sensor, the radar system 31 exemplarily includes a radar sensor 31b, as it is employed for the environmental capture in conventional vehicles. As the environmental sensor, the camera system 32 for example includes an environmental camera 32b, in particular a multi-function camera, as it is employed for the environmental capture in conventional vehicles. Alternative examples for environmental sensors are lidar sensor or ultrasonic sensors. How the environmental capture with such environmental sensors is realized, is known per se.

In order to execute the respective driving maneuver, the generated sensor data is further processed in suitable manner known per se, for example by way of known image analysis or object recognition algorithms. By the processing, a respective control signal for controlling the ego vehicle 20, in particular a corresponding vehicle actuator, such as for example a steering system, a braking system or a driving system, for executing or performing the respective driving maneuver is ascertained.

For evaluating or further processing the sensor data of the environmental camera 32b, the camera system 32 includes a transverse guidance module 32a. Analogously thereto, the radar system 31 includes a longitudinal guidance module 31a for evaluating the sensor data of the radar sensor 31b. The modules 31a and 32a can for example be realized as hardware or software module and/or as a hardware module with software portion. The respective module 31a, 32a can for example implement or include a decision logic or control logic to implement the required calculations and/or the required control for the respective driving maneuver. Thereto, the control logic can for example include a microprocessor or microcontroller. For example, a corresponding algorithm for the data processing and control signal generation can be implemented on the microcontroller in the form of program code.

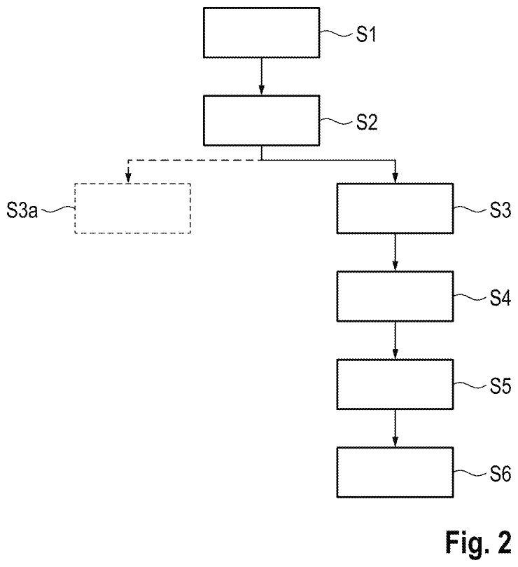

The (partially) automated performance of a lane change maneuver 21 is for example subject to legal requirements or standards in Europe and can be additionally or alternatively restricted by regulations internal to manufacturer. For example, a restriction is in that a predetermined first safety distance has to be complied with for example to foreign vehicles 14, 15 or to other traffic participants in front of or behind the ego vehicle 20 in direction of travel F. This means, the ego vehicle has to comply with a certain distance to the respective traffic participant in or after performing the respective driving maneuver. Presently, this first safety distance D1 is also referred to as target distance or minimum distance. If the target distance should not be able to be complied with in the lane change with the travel assist 30, the lane change procedure is usually aborted or suppressed, thus not initiated at all. Thereby, the availability of the (partially) automated lane change is reduced and customers for example lose the confidence in the function. Therefore, a method for operating the ego vehicle 20 is presently provided, in which longitudinal control objects are considered for safety distances in the assisted or automated lane change. The method can be described in more detail based on FIG. 2.

Hereto, FIG. 2 shows a schematic method flow diagram for a method for performing the lane change maneuver 21 in at least partially automated manner with the ego vehicle 20. Preferably, the method is performed or executed by way of the control logic of the transverse guidance module 32a. Thus, it is preferably a computer-implemented method. Presently, the method is exemplarily described in more detail based on the following situation. The ego vehicle 20 is driving on the ego lane 11, namely with active travel assist 30, this means that the longitudinal guidance system 31 and the transverse guidance system 32 are employed for the control of the ego vehicle 20. Now, the driver of the ego vehicle 20 wishes to change the lane, namely from the ego lane 11 to the target lane 12. For example, it is about overtaking the foreign vehicle 14. On the target lane 12, the foreign vehicle 15 is located, which is recognized by the used sensor technology of the travel assist 30 and is relevant to the performance of the lane change maneuver 21. In order to initiate the lane change maneuver 21, the driver or for example the transverse guidance module 32a or longitudinal guidance module 31a for example activates or indicates a direction indicator or turn signal 23 of the ego vehicle 20. Thus, the activation of the turn signal 23 initiates the lane change, which can be performed by executing the method described below.

In a step S1, the transverse guidance module 32a ascertains if a target object, thus for example the foreign vehicle 15, is located on the target lane 12. Thereto, the transverse guidance module 32a can for example analyze or evaluate the sensor signals of the radar sensor 32b. In a step S2, the transverse guidance module 32a ascertains the target distance (first safety distance D1) in relation to the foreign vehicle 15, which is relevant to the lane change maneuver 21, based on transverse guidance data. The transverse guidance data for example includes the results of the evaluation of the sensor signals of the environmental camera 32b. In addition, speed data can for example be encompassed by the transverse guidance data, which includes a driving speed of the ego vehicle 20 and of the foreign vehicle 15. Put another way, in the steps S1 and S2, it is about recognizing if or that the foreign vehicle 15 is on the target lane 12 in the target distance or will presumably enter into it in a critical target position during the lane change maneuver 21.

If the target distance would be violated in or by performing the lane change maneuver 21, thus the ego vehicle 20, as apparent in FIG. 1, would for example enter into the first safety distance D1, in step S3a, an abortion scenario is illustrated in the method flow diagram, as it would have been performed with previously known conventional travel assists 30. In the step S3a, the transverse guidance module 32a would recognize that the assisted lane change cannot be assisted due to the violated target distance. Thus, the lane change maneuver 21 would be aborted or not even be initiated. This means, the transverse guidance module 32a would for example not give an approval for the lane change.

In contrast, with the modified travel assist 30, as it is described in the present embodiment, it is possible to also use other safety distances than the target distance in the lane change maneuver 21. Therein, the activation state of the longitudinal guidance module 31a of the ego vehicle 20 is ascertained in a step S3. The activation state indicates that the longitudinal guidance module 31 is at least partially activated for performing the respective longitudinal guidance maneuver in automated manner. In a step S4, at least one control parameter is then ascertained, which indicates that the longitudinal guidance module 31a considers the respective target object, thus here the foreign vehicle 15, for the longitudinal guidance maneuver. This means, it is examined if the longitudinal guidance module 31a has captured the foreign vehicle 15 and adjusts to it.

If the longitudinal guidance module 31a is active and the control parameter is present, thus the foreign vehicle 15 is captured as the target object, a second safety distance D2, presently in particular a reduced distance in relation to the foreign vehicle 15, is ascertained in a step S5. Therein, the safety distance D2 is smaller than the safety distance D1 by a predetermined limit amount. In particular, the safety distance D2 is reduced by 50% compared to the safety distance D1. In the present embodiment, the reduced safety distance D2 is preferably an emergency braking distance N. By the emergency braking distance N, a distance is meant, which is just sufficient in order that an emergency braking assistant (not illustrated in FIG. 1) of the ego vehicle 20 can perform an emergency braking in automated or assisted manner and thus comes to a stop before the foreign vehicle 15 such that a collision can be avoided.

In a step S6, the lane change maneuver 21 is finally performed or executed or enabled by way of the transverse guidance module 32a in compliance with the reduced safety distance D2. In contrast, if the activation state and the control parameter are not present, the lane change maneuver 21 is not enabled or aborted.

Put another way, the camera system 32 recognizes that the foreign vehicle 15 is located on the target lane 12 in the first safety distance D1 or will presumably enter into it at a critical point of time during the lane change procedure. Furthermore, the camera system 32 recognizes that the foreign vehicle 15 is on the target lane 12 not in the safety distance D2 or will presumably not enter into it at a critical point of time during the lane change procedure. Preferably, a probability of entry that the foreign vehicle 15 enters into the reduced safety distance D2 should be less than 10%. If the system now recognizes that the longitudinal guidance is active and adjusts to the foreign vehicle 15, the approval for the assisted lane change is given thereupon.

In addition, further conditions can for example also be considered by the transverse guidance module 32a to initiate the lane change. For example, it can be ascertained if the longitudinal guidance is invalidated or overridden. Thereto, the transverse guidance module 32a can for example ascertain an override state of the longitudinal guidance module 31a. The override state indicates that the driver for example intervenes in the control of the ego vehicle 20 for performing a longitudinal guidance maneuver. Only if an override state is not present, the approval for the assisted lane change is given. In particular, it is also examined if all of the other relevant conditions for the lane change are satisfied. For example, conditions belong to it, which are preset by a traffic guidance or traffic announcements like a restriction on overtaking or a speed limit.

For example, the described method can also be employed if the lane change maneuver 21 is or was already initiated, thus the ego vehicle 20 is for example already in the lane change. If a foreign vehicle now unexpectedly appears, which violates the first safety distance D1, the lane change maneuver 21 does not have to be aborted and the ego vehicle 20 does not have to be moved back to the ego lane 11 as heretofore. Instead, the previously described method can be performed. Therein, it can for example be examined if the lane change maneuver 21 has been initiated by way of the transverse guidance module 32a in compliance with the target distance within a preceding predetermined time interval, for example of 1 to 5 seconds. Therein, the time interval serves for debouncing, such that a decision time is quasi given to the longitudinal guidance module 31a to adjust to the unexpectedly appeared target object as the control object.

Overall, the embodiments show the consideration of a longitudinal control object for safety distances in the assisted or automated lane change. Thus, it is overall possible to dynamically adjust the safety distance to remaining traffic participants in the road traffic and thereby to have to perform less abrupt driving maneuvers. Thereby, the wellbeing for passengers can be increased. In addition, the availability of a lane change function can thus be increased and the confidence in the function can be increased.

German patent application no. 10 2023 113 984.3, filed May 26, 2023, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for performing a lane change maneuver with a motor vehicle in an at least partially automated manner, the method comprising:
ascertaining a first safety distance of the motor vehicle in relation to a target object relevant to the lane change maneuver based on transverse guidance data of a transverse guidance module of the motor vehicle that performs the lane change maneuver;
ascertaining an activation state of a longitudinal guidance module of the motor vehicle, wherein the activation state indicates that the longitudinal guidance module is activated to perform a longitudinal guidance maneuver of the motor vehicle in an at least partially automated manner;
ascertaining at least one control parameter indicating that the longitudinal guidance module considers the target object for the longitudinal guidance maneuver;
only if the activation state and the control parameter are present, ascertaining a second safety distance of the motor vehicle in relation to the target object, wherein the second safety distance is different from the first safety distance by a predetermined limit amount; and
performing the lane change maneuver by way of the transverse guidance module in compliance with the second safety distance to the target object.

2. The method according to claim 1, further comprising:
ascertaining a lane change status of the transverse guidance module,
wherein the lane change status indicates that performing the lane change maneuver in compliance with the first safety distance to the target object has been initiated by way of the transverse guidance module within a preceding, predetermined time interval, and
wherein the second safety distance is additionally only ascertained if the lane change status is present.

3. The method according to claim 1, further comprising:
ascertaining a probability of entry of the target object into the second safety distance,
wherein the lane change maneuver is performed in compliance with the second safety distance only if the probability of entry falls below a preset limit value.

4. The method according to claim 1, further comprising:
ascertaining an override state of the longitudinal guidance module indicating that a passenger of the motor vehicle at least partially overrides the performing of the longitudinal guidance maneuver by way of the longitudinal guidance module by a driving intervention; and
preventing the performing the lane change maneuver in compliance with the second safety distance if the override state is present.

5. The method according to claim 1, wherein the second safety distance is reduced by the predetermined limit amount compared to the first safety distance.

6. The method according to claim 5, wherein the ascertaining the second safety distance includes considering an emergency braking distance to the target object for performing the longitudinal guidance maneuver, and wherein the emergency braking distance indicates a distance to the target object that is at least required for an emergency braking module to prevent a collision with the target object by way of an emergency braking maneuver.

7. The method according to claim 1, wherein the target object is a foreign vehicle on a target lane, onto which the motor vehicle is to be steered by performing the lane change maneuver.

8. The method according to claim 1, wherein each of the first safety distance and the second safety distance is set based on a vehicle speed of the motor vehicle and/or of the target object.

9. A motor vehicle with a transverse guidance module that performs a lane change maneuver and a longitudinal guidance module a longitudinal guidance maneuver, the motor vehicle comprising:
a processor; and
a memory storing program code that, when executed by the processor, causes the motor vehicle to:
ascertain a first safety distance of the motor vehicle in relation to a target object relevant to the lane change maneuver based on transverse guidance data of the transverse guidance module;
ascertain an activation state of the longitudinal guidance module of the motor vehicle, wherein the activation state indicates that the longitudinal guidance module is activated to perform the longitudinal guidance maneuver in at least a partially automated manner;
ascertain at least one control parameter indicating that the longitudinal guidance module considers the target object for the longitudinal guidance maneuver;
only if the activation state and the control parameter are present, ascertain a second safety distance of the motor vehicle in relation to the target object, wherein the second safety distance is different from the first safety distance by a predetermined limit amount; and
perform the lane change maneuver by way of the transverse guidance module in compliance with the second safety distance to the target object.

10. The motor vehicle according to claim 9, further comprising:
a camera system and a radar system, wherein the camera system includes the transverse guidance module and the radar system includes the longitudinal guidance module.
